(19) United States
(12) Patent Application Publication
(10) Pub. No.: US 2026/0122225 A1
(43) Pub. Date: Apr. 30, 2026

(54) DECODER-SIDE INTRA MODE DERIVATION GUIDED BY BLOCK VECTOR WITH ADAPTIVE HISTOGRAM

(71) Applicant: Tencent America LLC, Palo Alto, CA (US)

(72) Inventors: Biao WANG, Palo Alto, CA (US); Roman Chernyak, Palo Alto, CA (US); Yonguk Yoon, Palo Alto, CA (US); Lien-Fei Chen, Palo Alto, CA (US); Yifan Wang, Palo Alto, CA (US); Shan Liu, Palo Alto, CA (US); Ziyue Xiang, Palo Alto, CA (US)

(21) Appl. No.: 19/321,145

(22) Filed: Sep. 5, 2025

Related U.S. Application Data
(60) Provisional application No. 63/712,385, filed on Oct. 25, 2024.
(60) Provisional application No. 63/713,014, filed on Oct. 28, 2024.
(60) Provisional application No. 63/716,223, filed on Nov. 4, 2024.

(51) Int. Cl. H04N 19/11; H04N 19/105; H04N 19/176

(52) U.S. Cl. CPC H04N 19/11; H04N 19/105; H04N 19/176

(57) ABSTRACT

An example method of video decoding includes receiving a video bitstream comprising a plurality of blocks, including a current block. The method includes identifying an intra prediction mode for the current block which includes selecting multiple reference areas for the current block, each reference area of the multiple reference areas corresponding to a distinct reference block; generating a histogram from the multiple reference areas, including ceasing to generate the histogram when entries of the histogram meet a threshold value; and identifying an intra prediction mode based on one or more entries of the histogram. The method further includes decoding the current block using the intra prediction mode.

### RELATED APPLICATIONS

This application claims priority to U.S. Provisional Patent Application No. 63/712,385 entitled “Decoder-side Intra Mode Derivation Guided by Block Vector with Adaptive Histogram,” filed Oct. 25, 2024, to U.S. Provisional Patent Application No. 63/713,014 entitled “Occurrence-based Intra Prediction Guided by Block Vector,” filed Oct. 28, 2024, and to U.S. Provisional Patent Application No. 63/716,223 entitled “Vector Guided Decoder Side Intra Mode Derivation,” filed Nov. 4, 2024, which are hereby incorporated by reference in their entirety.

### TECHNICAL FIELD

The disclosed embodiments relate generally to video coding, including but not limited to systems and methods for decoder side intra mode derivations.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released. Enhanced Compression Model (ECM) is a video coding standard that is currently under development. ECM aims to significantly improve compression efficiency beyond existing standards like HEVC/H.265 and VVC, essentially allowing for higher quality video at lower bitrates. ECM version 13 was published on Jul. 7, 2024 in MPEG 146.

### SUMMARY

The present disclosure describes a set of methods for video (image) compression, including methods of block vector-guided decoder side intra prediction mode derivations, e.g., block matching cost-based intra prediction with multiple reference blocks associated with different block vectors. The decoder side gradient-based mode derivation process may include selecting multiple reference areas for the current block, each reference area being associated with a distinct reference block, and generating a histogram from the multiple reference areas. Using multiple reference areas to generate a histogram that is then used to identify an intra prediction mode allows for higher coding accuracy. For example, multiple block vectors may be fused to generate a more accurate prediction block.

In accordance with some embodiments, a method of video decoding includes (i) receiving a video bitstream (e.g., a coded video sequence) comprising a plurality of blocks, including a current block; (ii) identifying an intra prediction mode for the current block, including: (a) selecting multiple reference areas for the current block, each reference area of the multiple reference areas corresponding to a distinct reference block; (b) generating a histogram from the multiple reference areas, including ceasing to generate the histogram when entries of the histogram meet a threshold value; and (c) identifying an intra prediction mode based on one or more entries of the histogram; and (iii) decoding the current block using the intra prediction mode.

In accordance with some embodiments, a method of video encoding includes (i) receiving video data (e.g., a source video sequence) comprising a plurality of blocks, including a current block; (ii) identifying an intra prediction mode for the current block, including: (a) selecting multiple reference areas for the current block, each reference area of the multiple reference areas corresponding to a distinct reference block; (b) generating a histogram from the multiple reference areas, including ceasing to generate the histogram when entries of the histogram meet a threshold value; and (c) encoding the current block using the intra prediction mode. In some embodiments, the method also includes transmitting the encoded current block via a video bitstream.

In accordance with some embodiments, a method of video decoding includes (i) receiving a video bitstream (e.g., a coded video sequence) a plurality of blocks, including a current block; (ii) identifying a reference area for the current block; (iii) identifying a set of intra prediction modes by performing a gradient-based intra mode derivation on the reference area, including applying an edge filter to reference samples of the reference area; (iv) selecting an intra prediction mode from the set of intra prediction modes; and (v) decoding the current block using the intra prediction mode.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates spatial neighboring candidates for mode occurrence collection in accordance with some embodiments.

FIG. 4B illustrates an example of a histogram of occurrences of intra modes in the spatial neighborhood of current block in accordance with some embodiments.

FIG. 4C illustrates decoder-side gradient based intra mode derivation in accordance with some embodiments.

FIG. 4D illustrates the use of a line of reconstructed samples in a template to derive an intra mode in accordance with some embodiments.

FIG. 5A illustrates an example of block vector-guide templates to build a histogram in accordance with some embodiments.

FIG. 5B illustrates an example current template and reference template to obtain block matching costs in accordance with some embodiments.

FIG. 5C illustrates an example current template and reference template to obtain block matching costs in accordance with some embodiments.

FIG. 5D illustrates an example of early termination condition of histogram of occurrences (HoC) building in accordance with some embodiments.

FIG. 5E illustrates an example of early termination condition of histogram of gradients (HoG) building in accordance with some embodiments.

FIG. 6A illustrates an example video decoding process in accordance with some embodiments.

FIG. 6B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes a set of methods for video (image) compression, including methods of block vector-guided decoder side intra prediction mode derivations, e.g., block matching cost-based intra prediction with multiple reference blocks associated with different block vectors. For example, up to N reference areas (e.g., pointed by N block vectors respectively) may be used to build the histogram of occurrences in an intra mode derivation that is based on the occurrence of intra mode on the neighboring blocks. As another example, when block vectors are available from multiple neighboring blocks, decoder-side gradient based intra mode derivation may be applied to reference blocks corresponding to neighboring block vectors. Using multiple reference areas can increase the accuracy of the corresponding prediction, which improves coding efficiency.

### Example Systems and Devices

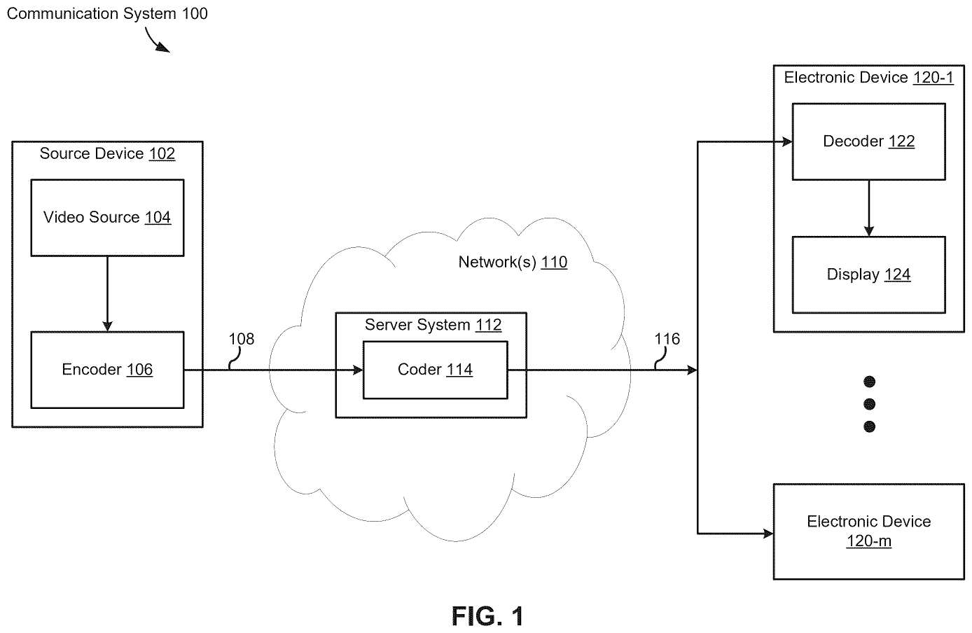

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including, e.g., wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116. In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

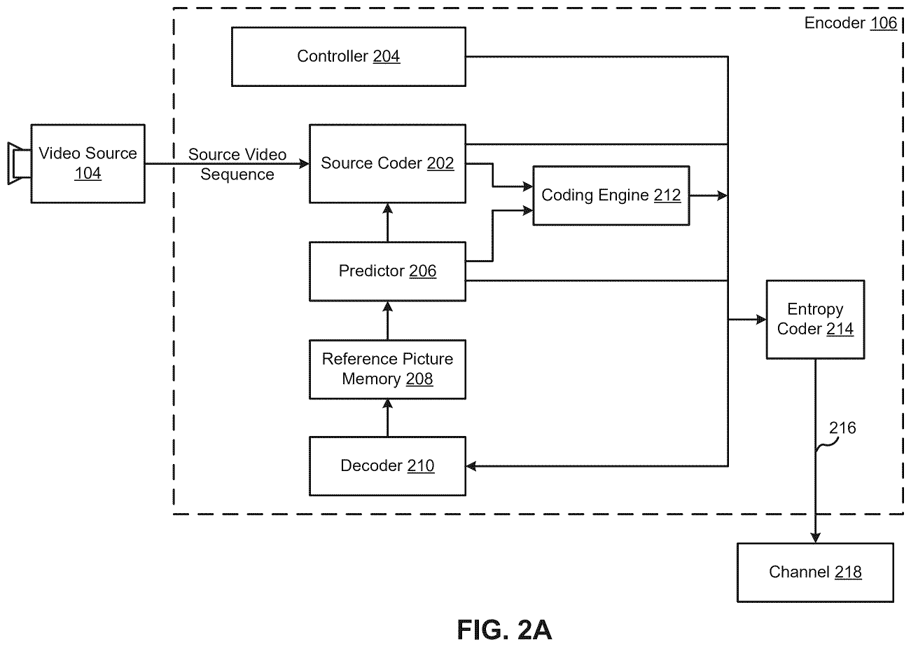

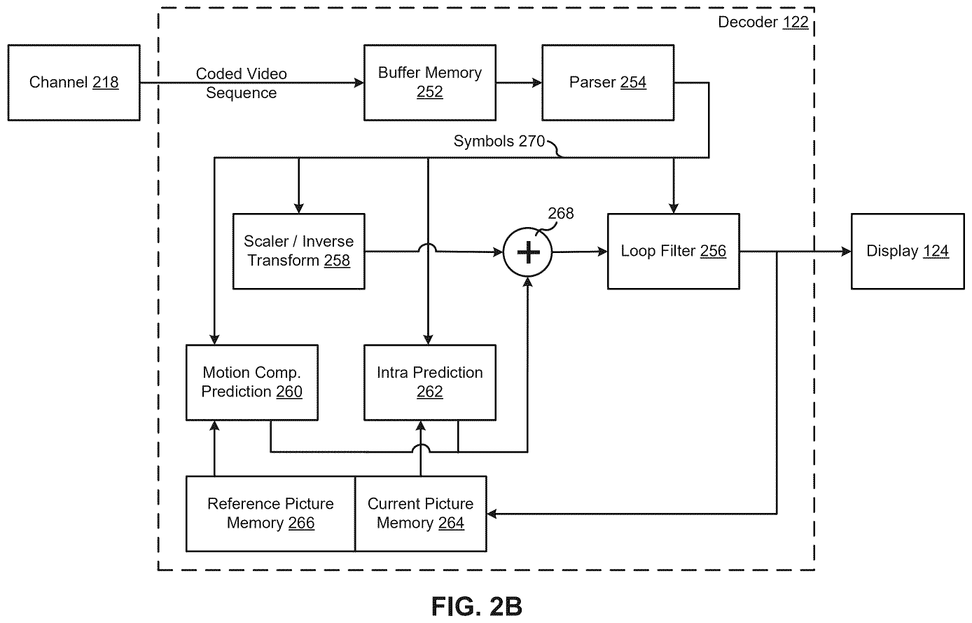

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, e.g., setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (e.g., blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, e.g., coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, e.g., information used to manage operation of the decoder component 122, and/or information to control a rendering device such as the display 124. The control information for the rendering device(s) may be in the form of, e.g., Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, e.g., X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (e.g., by parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. Levels may restrict the maximum picture size, maximum frame rate, maximum reconstruction sample rate (measured in, e.g., megasamples per second), maximum reference picture size, and so on. Limits set by levels may be further restricted through Hypothetical Reference Decoder (HRD) specifications and metadata for HRD buffer management signaled in the coded video sequence.

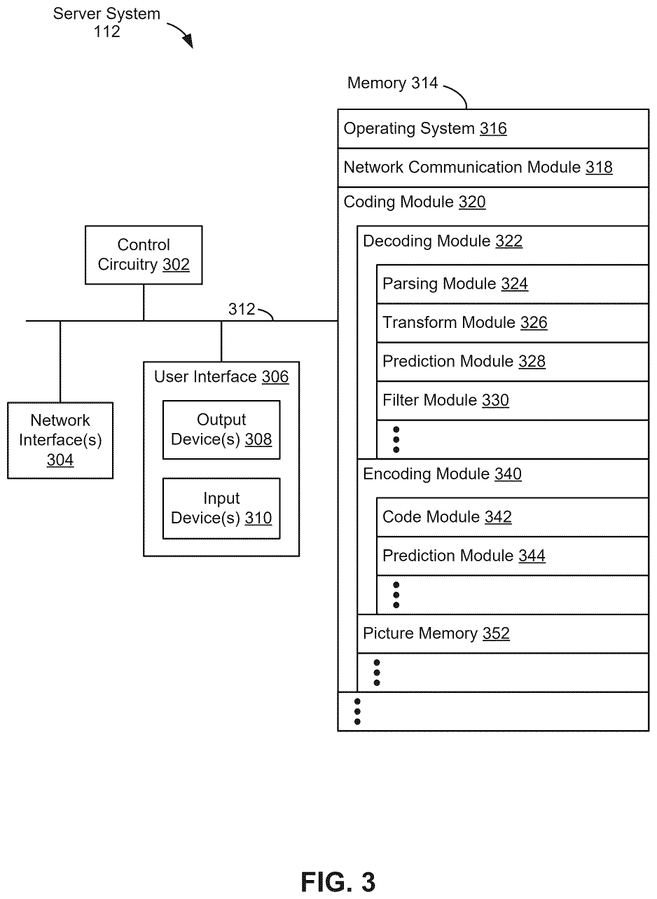

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). The present disclosure covers block vector-guided decoder side intra prediction mode derivations, e.g., block matching cost-based intra prediction with multiple reference blocks associated with different block vectors. The decoder side gradient-based mode derivation process may include selecting multiple reference areas for the current block, each reference area being associated with a distinct reference block and generating a histogram from the multiple reference areas. Using multiple reference areas to generate a histogram that is then used to identify an intra prediction mode allows for higher coding accuracy. For example, multiple block vectors may be fused to generate a better prediction block.

In some approaches, intra prediction explores spatial redundancy between a current block and its neighboring samples. Conventionally, intra prediction modes can be classified as directional and non-directional modes, indicating their directional or non-directional correlation between neighboring reference blocks and the current block. Examples of non-directional intra prediction mode include planar mode and DC mode.

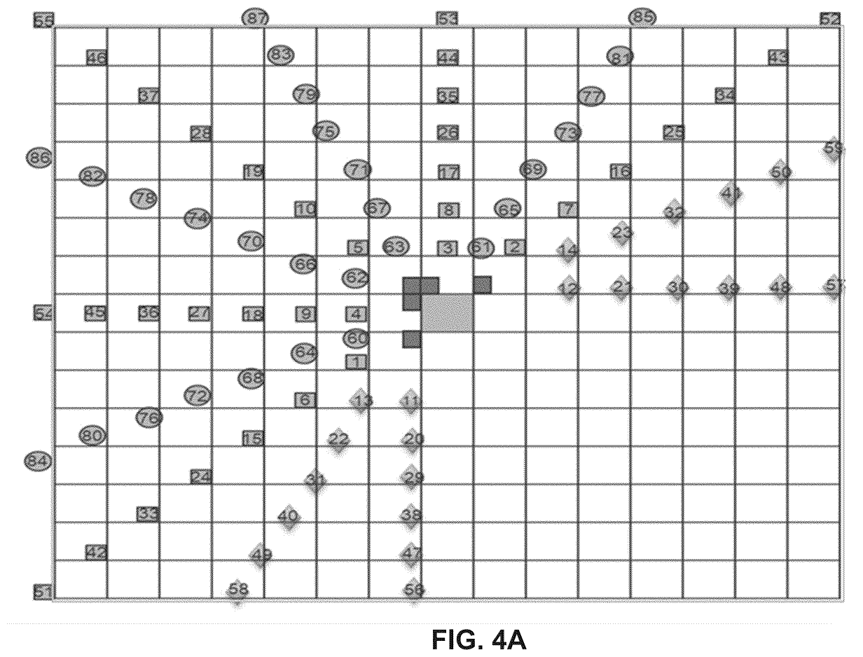

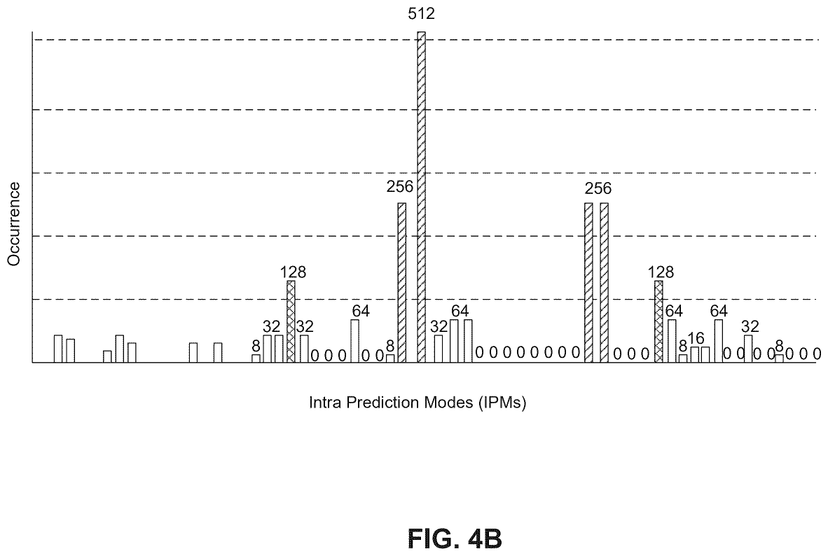

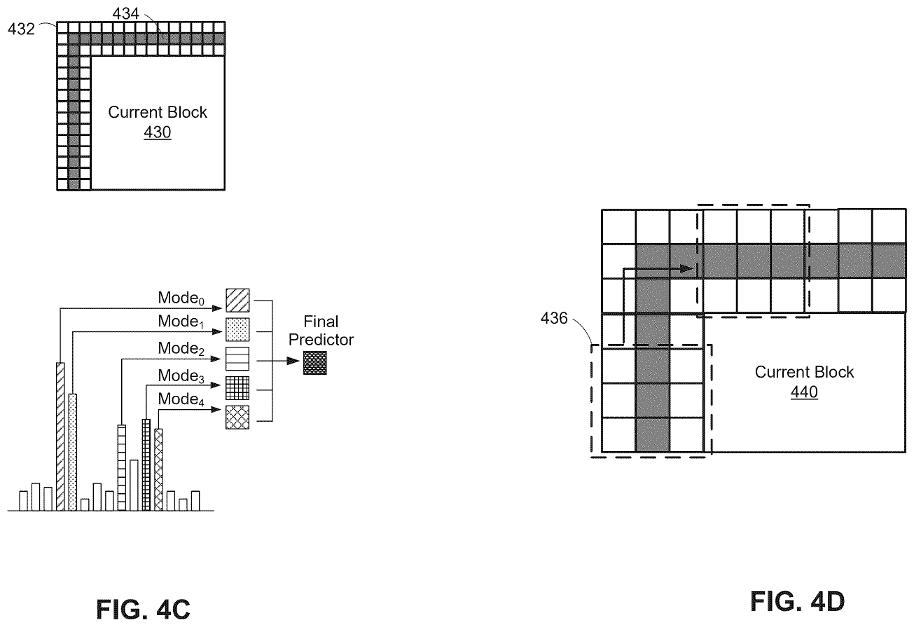

In some approaches, the intra mode information is explicitly signaled via syntax in the bitstream. Based on the signaled intra mode, a corresponding predictor is generated based on reference samples (e.g., using an interpolation filter applied on reference samples). In some approaches, the intra mode is implicitly derived from the decoder side. In such cases, the intra mode information is derived from a predefined area of reconstructed samples. In some occurrence-based methods, as illustrated in FIG. 4A, the intra mode derivation of a current block is based on the occurrences of different intra prediction modes in both adjacent and non-adjacent neighboring blocks, this occurrence-based method is also sometimes referred hereinafter as “method A”. By checking the occurrence of various intra prediction modes in the neighbouring blocks, a Histogram of occurrence (HoC) is built based on the intra modes and their sample-wise occurrences. The sample-wise occurrence values may be calculated based on the number of samples that are coded in a respective intra prediction mode in a neighborhood block. FIG. 4B illustrates an example of a HoC in accordance with some embodiments. The N intra modes with the highest occurrences (e.g., N highest occurrences) are used to generate respective predictors, and a final prediction signal is a fusion of these predictors. In some circumstances, using fixed predefined positions of neighboring locations to generate the HoC may result in sub-optimal intra mode derivation.

In addition to occurrence-based methods, another decoder side intra mode derivation includes gradient-based intra mode derivation, which is a statistics-based approach that generates a histogram of gradients (HoG) using adjacent neighboring reconstructed samples, or a template, of the current block, this method is also sometimes referred hereinafter as “method B”. Based on the histogram, the top N gradients may be mapped to one (conventional) intra mode, and those predictors may be combined to generate a final predictor. In addition, the derived intra prediction modes can be included in a most probable mode candidate list. FIG. 4C shows an example of decoder-side gradient-based intra mode derivation having three lines of neighboring samples (hereinafter also sometimes referred to as a template 432) considered. The histogram of gradients accounts only for samples in a middle reference line 434, as indicated by the shaded samples in FIG. 4C. The other two neighboring lines (e.g., the higher and lower reference lines) in the template 432 are used to calculate the gradient of the samples in the reference middle line 434. In some approaches, the texture direction of neighboring samples is estimated as illustrated in FIG. 4D. First, a horizonal Sobel filter and a vertical Sobel filter (e.g., a Sobel 3×3 filter) is applied on a window of the same size (e.g., a 3×3 window) having the grey samples of the middle reference line 434 in the template 432, to get a horizonal gradient Gx and a vertical gradient Gy. Next, a ratio of Gx and Gy is calculated for each 3×3 window 436 within the template 432 (e.g., the intra mode information of neighboring template). The ratio of Gx and Gy may be matched to a conventional intra prediction mode that is closest to the ratio and the intra prediction mode is counted in a histogram. The 3×3 window 436 is slid across the template 432 and the histogram is updated according to the matched intra mode for each 3×3 window. In some circumstances, using a fixed number of samples in a single line of template to build a histogram of gradient may result in sub-optimal intra mode derivation.

In some circumstances, the use of the decoder-side intra prediction mode derivation reduces signaling overhead. Another decoder-side intra prediction mode derivation includes template cost-based intra prediction mode derivation. A template cost-based intra prediction exploits the fact that if the neighboring samples of current block are well correlated, then a prediction mode that works well for the neighboring samples would probably also work well for the current block. Gradient-based intra mode derivation generates a histogram of gradients (HoG) using adjacent neighboring samples of the current block, as illustrated in FIG. 4C. Based on the histogram, the top N gradients are mapped to an intra mode, and those predictors are combined as a final predictor. In addition, derived intra prediction modes can be included in the most probable mode candidate list. FIG. 4C shows an example of decoder-side gradient based intra mode derivation.

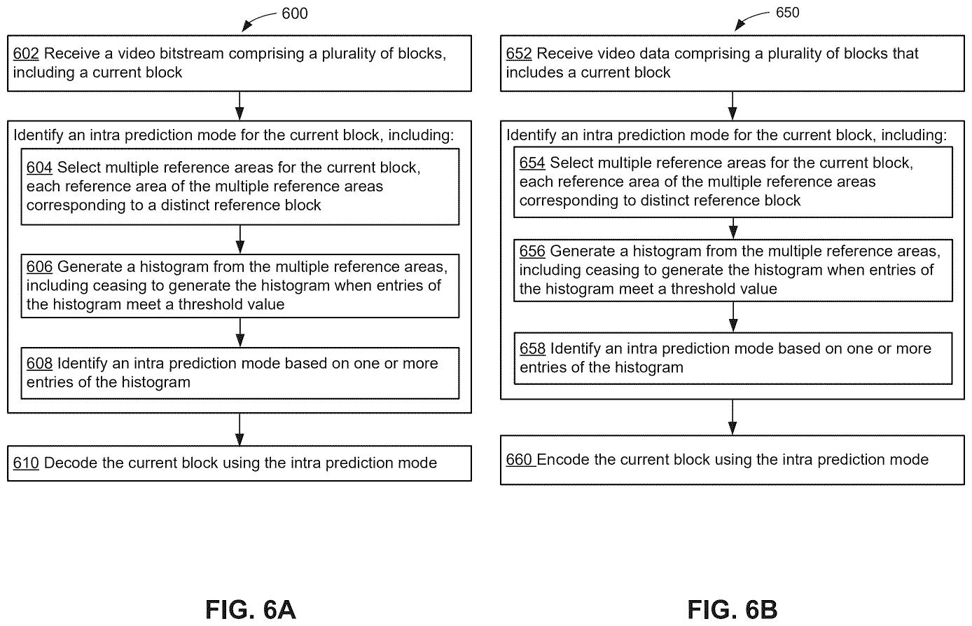

FIG. 6A is a flow diagram illustrating a method 600 of decoding video in accordance with some embodiments. The method 600 may be performed at a computing system (e.g., the server system 112, the source device 102, or the electronic device 120) having control circuitry and memory storing instructions for execution by the control circuitry. In some embodiments, the method 600 is performed by executing instructions stored in the memory (e.g., the memory 314) of the computing system.

The system receives (602) a video bitstream (e.g., a coded video sequence) comprising a plurality of blocks (e.g., corresponding to one or more frames), including a current block. The system identifies an intra prediction mode for the current block, including the system selecting (604) multiple reference areas for the current block, each reference area of the multiple reference areas corresponding to a distinct reference block; the system generating (606) a histogram from the multiple reference areas, including ceasing to generate the histogram when entries of the histogram meet a threshold value; and the system identifying (608) an intra prediction mode based on one or more entries of the histogram. The system decodes (610) the current block using the intra prediction mode.

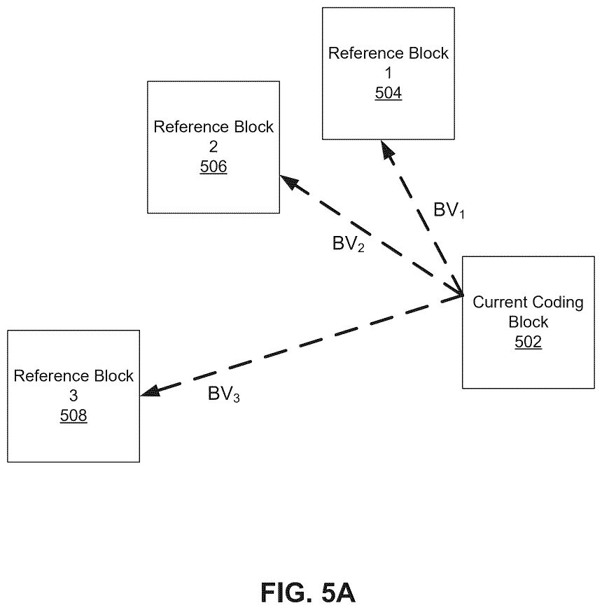

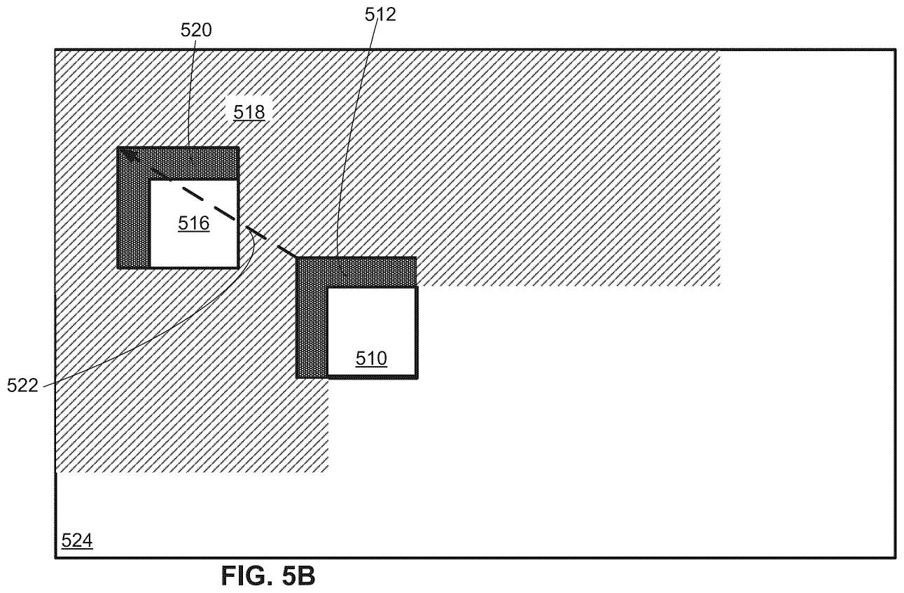

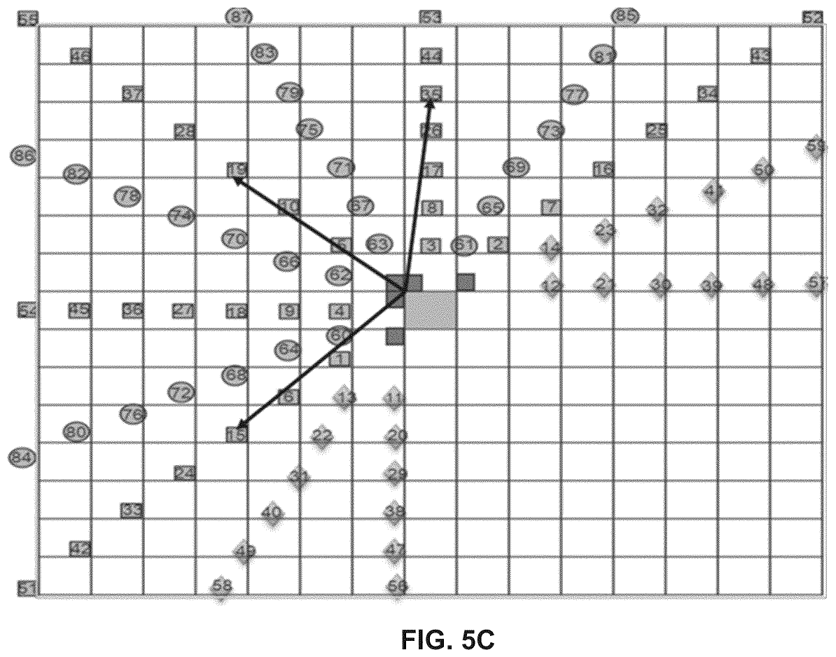

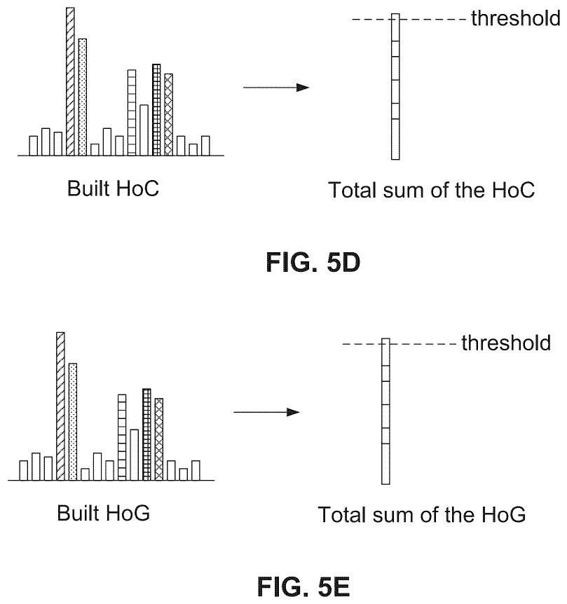

In some embodiments, up to N reference areas (e.g., pointed by N respective block vectors) are used, as exemplified in FIG. 5A, where N=3, and the three block vectors are BV₁, BV₂, and BV₃, to build a histogram of occurrences (HoC) according to method A. In some embodiments, the block vectors are obtained by searching in a predefined reconstructed area (e.g., a reconstructed area 518 in FIG. 5B). The N block vectors with the least N block matching costs are used to guide the reference areas (e.g., a first reference block 504, a second reference block 506, and a third reference block 508 in FIG. 5A). In some embodiments, the number of block vectors changes based on a threshold value. For example, only block vectors whose block matching costs (e.g., template-based costs) are smaller than this threshold are used to build the HoC. In some embodiments, block matching costs include SAD or SATD cost between a reference template 520 and a current template 512, as shown in FIG. 5C. In some embodiments, a list of block matching costs in ascending order is generated, and a new entry from a specific position (e.g., based on a scanning order) is inserted based on the associated cost.

In some embodiments, among the up to N block vectors are M (M<=N) block vectors that are constrained within the predefined area in method A, as shown in FIG. 5C. For example, a subset of the N block vectors (e.g., the first M block vectors) is selected. FIG. 5C shows how a current template and a reference template are used to obtain the block matching cost. For example, the dark squares surrounding the central gray rectangle representing the current block are the positions that are directly adjacent the current block. The rhombus shapes having reference numerals 11-14, 20-23, 29-32, 38-41, 47-50, and 56-59 are optional and correspond to wide angle and/or nonexistent intra modes. The ovals and the rectangles correspond to usual and/or normal intra modes. The reference numerals denote the scan order in which the associated positions are checked.

In some embodiments, both the block vector pointed positions (e.g., represented by an arrow 522 illustrated in FIG. 5B) and the predefined positions (e.g., illustrated in FIG. 5C) are checked to build the HoC. In some embodiments, a list of block vectors {BV₀, BV₁, BV₂, . . . , BVₘ} within the predefined positions are built and sorted by the block matching cost in ascending order. When a block vector pointed position and a predefined position are contained in a same coding block, then predefined position is skipped to prune duplicated entries.

In some embodiments, a threshold value is set for building the HoC. If a condition based on the threshold value is met, building of the HoC is terminated. In some embodiments, the threshold value used to terminate the building of the HoC is determined based on block size information. In some embodiments, a condition to terminate the building of the HoC is satisfied when the accumulated histogram of gradients is larger than and/or equal to the set threshold, as shown in FIG. 5D.

In some embodiments, up to N reference areas (pointed by N respective block vectors) are used, as exemplified in FIG. 5A where N=3, to build a histogram according to method B. Furthermore, a threshold value is set for building the histogram, if a condition based on the threshold value is met, the building of the histogram is terminated.

In some embodiments, block vectors (e.g., BV₁, BV₂, and BV₃ in FIG. 5A) are obtained by searching in a predefined reconstructed area (e.g., a reconstructed area 518 in FIG. 5B). The N block vectors with the least N block matching costs are used to guide the reference areas (e.g., a first reference block 504, a second reference block 506, and a third reference block 508 in FIG. 5A).

In some embodiments, building of the histogram starts from a reference block, pointed by a block vector, with the least block matching cost to a reference block with the highest block matching cost. In some embodiments, the block matching cost includes the SAD or SATD cost between a reference template 520 and a current template 512, as shown in FIG. 5B.

In some embodiments, the threshold value used to terminate the building of the histogram is determined based on block size information. In some embodiments, a condition to terminate the building of the histogram occurs when an accumulated histogram of gradients (HoG) is larger than and/or equal to the set threshold, as shown in FIG. 5E. For example, FIG. 5E shows an early termination condition of the histogram building process based on a threshold value. The threshold is in turn determined based on block size.

In some embodiments, N areas used to build the histogram come from two sources, one is from the (N−1) block vector-guided areas, and the remaining area is from the original adjacent template. In some embodiments, the original adjacent template is first used to generate the histogram. In some embodiments, the original adjacent template is used last to generate the histogram.

In some embodiments, when block vectors are available from neighboring blocks (e.g., hereinafter also sometimes referred to as neighboring block vectors), decoder-side gradient based intra mode derivation is applied to reference blocks corresponding to neighboring block vectors. Derived intra modes are used to generate the current block's prediction. FIG. 5A illustrates three reference blocks corresponding to three block vectors. In this way, instead of searching for the block vectors directly, the system can access its memory to obtain the block vectors inherited from neighboring blocks. In some embodiments, available block vectors are searched using information from neighboring blocks (e.g., hereinafter also sometimes referred to as neighboring information).

In some embodiments, the neighboring information is derived from predefined adjacent and/or non-adjacent positions. In some embodiments, when a block vector is available from a neighboring block, decoder-side gradient based intra mode derivation is applied to the reference block corresponding to the block vector. In some embodiments, from a calculated HoG, top N intra modes are used to predict the current block and the N prediction blocks are fused as the final prediction.

In some embodiments, when multiple block vectors are available from neighboring blocks, decoder-side gradient based intra mode derivation is applied to each reference block corresponding to each block vector of the multiple block vectors. From each calculated HoG, the best intra mode (e.g., a mode having a highest occurrence, and/or selecting a mode from a position that is associated with multiple modes) is used to predict the current block and the prediction blocks are fused as the final prediction.

In some embodiments, when motion vectors (e.g., for inter predictions) are available from neighboring blocks, reference blocks in a reference frame can be used. In some embodiments, available block vectors are searched using information from neighboring blocks (e.g., hereinafter also sometimes referred to as neighboring information) and applied to reference blocks in the reference frame to generate the final prediction. In some embodiments, the neighboring information is derived from predefined adjacent and/or non-adjacent positions and applied to reference blocks in the reference frame to generate the final prediction.

In some embodiments, a flag is signaled to indicate whether the vector-guided intra mode derivation is used to predict the current block. In some embodiments, when there are no block vectors from neighboring blocks, the flag is inferred as false.

FIG. 6B is a flow diagram illustrating a method 650 of encoding video in accordance with some embodiments. The method 650 may be performed at a computing system (e.g., the server system 112, the source device 102, or the electronic device 120) having control circuitry and memory storing instructions for execution by the control circuitry. In some embodiments, the method 650 is performed by executing instructions stored in the memory (e.g., the memory 314) of the computing system. In some embodiments, the method 650 is performed by a same system as the method 600 described above.

The system receives (652) video data (e.g., a source video sequence) comprising a plurality of blocks (e.g., corresponding to a set of pictures) that includes a current block. The system identifies an intra prediction mode for the current block, including the system selecting (654) multiple reference areas for the current block, each reference area of the multiple reference areas corresponding to a distinct reference block; the system generating (656) a histogram from the multiple reference areas, including ceasing to generate the histogram when entries of the histogram meet a threshold value; and the system identifying (658) an intra prediction modes based on one or more entries of the histogram. The system encodes (660) the current block using the intra prediction mode. In some embodiments, the system encodes the current block using information of one or more syntax elements. In some embodiments, the system transmits the one or more encoded syntax elements and the encoded current block via a video bitstream. As described previously, the encoding process may mirror the decoding processes described herein (e.g., using block vector-guided decoder side gradient-based mode derivation with block matching cost-based intra prediction). For brevity, those details are not repeated here.

Although FIGS. 6A and 6B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

(A1) In one aspect, some embodiments include a method (e.g., the method 600) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks, including a current block; (ii) identifying an intra prediction mode for the current block, including: (a) selecting multiple reference areas for the current block, each reference area of the multiple reference areas corresponding to a distinct reference block; (b) generating a histogram from the multiple reference areas, including ceasing to generate the histogram when entries of the histogram meet a threshold value; and (c) identifying an intra prediction mode based on one or more entries of the histogram; and (iii) decoding the current block using the intra prediction mode. In this way, up to N reference areas (e.g., pointed by N block vectors respectively) are used to build the histogram, e.g., where N=3. Furthermore, a threshold value is given while building the histogram, if a condition based on the threshold value is met, the building of histogram is terminated. The histogram may be a histogram of occurrences (HoC) and/or a histogram of gradients (HoG). As an example, reference blocks pointed at by block vectors (rather than the neighboring samples) may be used to build HoG and derive intra modes.

(A2) In some embodiments of A1, the multiple reference areas are selected from a predefined reconstruction area based on respective costs. For example, the block vectors are obtained by searching in a pre-defined reconstructed area. The N block vectors with the least N block matching cost are used to guide the reference areas.

(A3) In some embodiments of A2, generating the histogram comprises using a reference area of the multiple reference areas that has the lowest cost before using other reference areas of the multiple reference areas. For example, the building of histogram starts from the reference block pointed by block vector with the least block matching cost to the reference block pointed by block vector with the most block matching cost.}

(A4) In some embodiments of A2 or A3, the respective costs comprise at least one of a sum of absolute difference (SAD) cost and a sum of absolute transform difference (SATD) cost. For example, block matching cost could be but not limit to the SAD or SATD cost between the reference template and current template.

(A5) In some embodiments of any of A2-A4, a number of the multiple reference areas selected is based on a cost threshold. For example, the number of block vectors might change based on a threshold value. For example, only block vectors whose cost is smaller than this threshold may be used to build the HoC.

(A6) In some embodiments of any of A1-A5, the threshold value for the histogram is based on block size information corresponding to the current block. For example, the threshold value used to terminate the building histogram is determined based on block size information. The condition to terminate the building histogram is when the accumulated histogram of gradients is larger than and/or equal to the given threshold, as shown in FIG. 5D.

(A7) In some embodiments of any of A1-A6, at least a subset of the multiple reference areas is identified based on one or more block vectors. For example, the N areas used to build the histogram come from two sources, one is from (N−1) block vector-guided area, and the remaining area is from the original adjacent template. As an example, up to N reference areas (pointed by N block vectors respectively) are used to build the histogram of occurrences.

(A8) In some embodiments of A7, the one or more block vectors are identified in accordance with a predefined scanning order. For example, among the up to N block vectors there are M (M<=N) block vectors are constrained within the pre-defined area, as shown in FIG. 5C.

(A9) In some embodiments of A7 or A8, the one or more block vectors are identified based on neighboring information for the current block. For example, available block vectors can be searched from neighboring information. As an example, neighboring information can be derived from predefined adjacent and/or non-adjacent positions.

(A10) In some embodiments of A9, the one or more block vectors are available block vectors from one or more neighboring blocks of the current block. For example, when a block vector is available from neighboring blocks, decoder-side gradient based intra mode derivation is applied to reference block corresponding to the block vector. From a calculated HoG, the top N intra modes can be used to predict the current block and N prediction blocks can be fused as the final prediction.

(A11) In some embodiments of A10, the method further comprising applying a gradient based intra mode derivation to a respective reference block indicated by each of the one or more block vectors.

(A12) In some embodiments of any of A7-A11, at least a second subset of the multiple reference areas is identified by checking a set of predefined positions. For example, both the block vector pointed positions and pre-defined positions are checked to build the HoC. As an example, a list of block vectors {BV₀, BV₁, BV₂, . . . , BVₘ} within the pre-defined positions are built and sorted by the block matching cost in ascending order. When block vector pointed position and pre-defined position are contained in a same coding block, then pre-defined position is skipped.

(A13) In some embodiments of any of A7-A12, the multiple reference areas include a reference area corresponding to an adjacent template for the current block. For example, when plural block vectors are available from neighboring blocks, decoder-side gradient based intra mode derivation is applied to each reference block corresponding to each block vector. From each calculated HoG, the best intra mode can be used to prediction the current block and prediction blocks can be fused as the final prediction.

(A14) In some embodiments of A13, generating the histogram comprises using the reference area corresponding to the adjacent template for the current block before using other reference areas of the multiple reference areas. For example, the original adjacent template is visited firstly to collect histogram.

(A15) In some embodiments of A13, generating the histogram comprises using the reference area corresponding to the adjacent template for the current block after using other reference areas of the multiple reference areas. For example, the original adjacent template is visited lastly to collect histogram.

(A16) In some embodiments of any of A1-A15, at least a subset of the multiple reference areas is identified based on one or more motion vectors. For example, when motion vectors are available from neighboring blocks, reference blocks in reference frame can be used. Gradient based intra mode derivation can be applied to reference blocks in reference frame to generate the final prediction.

(A17) In some embodiments of any of A1-A16, the method further comprises parsing a first flag from the video bitstream, the first flag indicating whether a vector-guided intra mode derivation is to be used for the current block. For example, a flag can be signaled whether the vector-guided intra mode derivation is used to predict the current block. As an example, when there is not block vectors from neighboring blocks, the flag can be inferred as false.

(A18) In some embodiments of any of A1-A17, the multiple reference areas comprise three reference areas.

(B1) In another aspect, some embodiments include a method (e.g., the method 750) of video encoding. In some embodiments, the method is performed at a computing system having memory and one or more processors. The method includes: (i) receiving video data comprising a plurality of blocks, including a current block; (ii) identifying an intra prediction mode for the current block, including: (a) selecting multiple reference areas for the current block, each reference area of the multiple reference areas corresponding to a distinct reference block; (b) generating a histogram from the multiple reference areas, including ceasing to generate the histogram when entries of the histogram meet a threshold value; and (c) identifying an intra prediction mode based on one or more entries of the histogram; (iii) encoding the current block using the intra prediction mode.

(B2) In some embodiments of B1, the method further comprises transmitting the current block via a video bitstream.

(B3) In some embodiments of B1 or B2, the method further comprises the encoding-side analogue of any of the techniques described above in A2-A18.

(C1) In one aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks, including a current block; (ii) identifying a reference area for the current block; (iii) identifying a set of intra prediction modes by performing a gradient-based intra mode derivation on the reference area, including applying an edge filter to reference samples of the reference area; (iv) selecting an intra prediction mode from the set of intra prediction modes; and (v) decoding the current block using the intra prediction mode. In this way, one or more simplified edge filters is/are used in the gradient-based intra mode derivation method to derive a conventional intra prediction mode when a non-conventional intra prediction mode is applied for the prediction of the current block. The derived intra prediction mode may be used to determine the intra mode required by other coding stages. The derived intra prediction mode may be used to determine the intra mode required by other coding stages. The other coding stages include but are not limited to predicting chroma components from collocated luma components using direct mode or building a most probable mode list for mode propagation or selecting a transform kernel.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., the methods 600 and 650, as well as A1-A18, B1-B3, and C1 above).

In another aspect, some embodiments include a non-transitory computer-readable storage medium storing one or more sets of instructions for execution by control circuitry of a computing system, the set(s) of instructions including instructions for performing any of the methods described herein (e.g., the methods 600 and 650, as well as A1-A18, B1-B3, and C1 above). In some embodiments, a memory or non-transitory computer-readable storage medium stores a video bitstream including any of the features (e.g., syntax and encoded information) disclosed herein.

Unless otherwise specified, any of the syntax elements described herein may be HLS. As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block;
identifying an intra prediction mode for the current block, including:
selecting multiple reference areas for the current block, each reference area of the multiple reference areas corresponding to a distinct reference block;
generating a histogram from the multiple reference areas, including ceasing to generate the histogram when entries of the histogram meet a threshold value; and
identifying an intra prediction mode based on one or more entries of the histogram; and
decoding the current block using the intra prediction mode.

2. The method of claim 1, wherein the multiple reference areas are selected from a predefined reconstruction area based on respective costs.

3. The method of claim 2, wherein generating the histogram comprises using a reference area of the multiple reference areas that has the lowest cost before using other reference areas of the multiple reference areas.

4. The method of claim 2, wherein the respective costs comprise at least one of a sum of absolute difference (SAD) cost and a sum of absolute transform difference (SATD) cost.

5. The method of claim 2, wherein a number of the multiple reference areas selected is based on a cost threshold.

6. The method of claim 1, wherein the threshold value for the histogram is based on block size information corresponding to the current block.

7. The method of claim 1, wherein at least a subset of the multiple reference areas is identified based on one or more block vectors.

8. The method of claim 7, wherein the one or more block vectors are identified in accordance with a predefined scanning order.

9. The method of claim 7, wherein the one or more block vectors are identified based on neighboring information for the current block.

10. The method of claim 9, wherein the one or more block vectors are available block vectors from one or more neighboring blocks of the current block.

11. The method of claim 10, further comprising applying a gradient based intra mode derivation to a respective reference block indicated by each of the one or more block vectors.

12. The method of claim 7, wherein at least a second subset of the multiple reference areas is identified by checking a set of predefined positions.

13. The method of claim 7, wherein the multiple reference areas include a reference area corresponding to an adjacent template for the current block.

14. The method of claim 13, wherein generating the histogram comprises using the reference area corresponding to the adjacent template for the current block before using other reference areas of the multiple reference areas.

15. The method of claim 13, wherein generating the histogram comprises using the reference area corresponding to the adjacent template for the current block after using other reference areas of the multiple reference areas.

16. The method of claim 1, wherein at least a subset of the multiple reference areas is identified based on one or more motion vectors.

17. The method of claim 1, further comprising parsing a first flag from the video bitstream, the first flag indicating whether a vector-guided intra mode derivation is to be used for the current block.

18. The method of claim 1, wherein the multiple reference areas comprise three reference areas.

19. A method of video encoding performed at a computing system having memory and one or more processors, the method comprising:
receiving video data comprising a plurality of blocks, including a current block;
identifying an intra prediction mode for the current block, including:
selecting multiple reference areas for the current block, each reference area of the multiple reference areas corresponding to a distinct reference block;
generating a histogram from the multiple reference areas, including ceasing to generate the histogram when entries of the histogram meet a threshold value; and
identifying an intra prediction mode based on one or more entries of the histogram; and
encoding the current block using the intra prediction mode.

20. A non-transitory computer-readable storage medium storing a video bitstream that is generated by a video encoding method, the video encoding method comprising:
selecting multiple reference areas for a current block of a plurality of blocks of video data, each reference area of the multiple reference areas corresponding to a distinct reference block;
generating a histogram from the multiple reference areas, including ceasing to generate the histogram when entries of the histogram meet a threshold value; and
identifying an intra prediction mode based on one or more entries of the histogram; and
encoding the current block using the identified intra prediction mode; and
wherein the video bitstream comprises the encoded current block.
